(19) United States
(12) Patent Application Publication
(10) Pub. No.: US 2003/0151514 A1
(43) Pub. Date: Aug. 14, 2003

(54) Shark detection and warning system

(76) Inventor: Thomas Randall Sargent, Cotati, CA (US)

Correspondence Address: Thomas Randall Sargent, 617 Speers Road, Santa Rosa, CA, 95409, US

(21) Appl. No.: 10/073,587

(22) Filed: Feb. 12, 2002

(51) Int. Cl. G08B 23/00

(52) U.S. Cl. 340/573.2

(57) ABSTRACT

This invention consists of a system of components with electronic sensors that sense the presence of sharks within their vicinity and relays a warning to the various components within the system. The main components are the buoys and personal warning reception devices. The buoy system utilizes sonar and other technologies to detect objects in the water; this data is fed to a microprocessor that distinguishes sharks from other marine life based on size, shape, and other distinguishing characteristics.

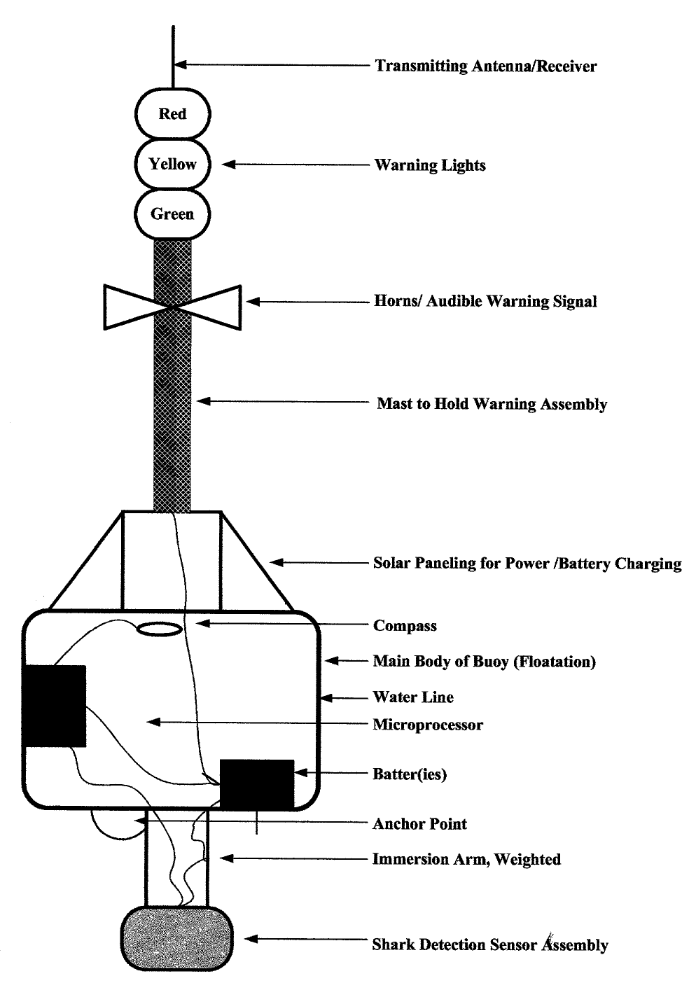

### CROSS-REFERENCE TO RELATED APPLICATIONS

This patent application claims the potential benefit of some or all of the following patents: U.S. Pat. Nos. 5,612,928—5,414,675—5,299,173—5,184,330—4,686,532—4,651,309 3,967,233 6,160,756—6,084,827—6,052,485—6,009,044—5,973,997—5,526,323—5,438,552—5,251,185 5,181,254—4,829,493

### STATEMENT REGARDING FED SPONSORED RESEARCH & DEVELOPMENT

Not Applicable.

### SPECIFICATION

This invention consists of a system of components with electronic sensors that sense the presence of sharks within their vicinity and relays a warning to the various components within the system. The main components are the buoys and personal warning reception devices. The buoys utilize sonar to detect objects in the water; this data is fed to a microprocessor on the buoy that distinguishes sharks from other marine life based on size, shape, and other distinguishing characteristics.

### REFERENCE TO SEQUENCE LISTING, A TABLE, OR COMPUTER PROGRAM LISTING APPENDIX

Not Applicable.

### BACKGROUND OF THE INVENTION

This invention pertains to the field of water safety. Shark attacks, though rare, are cause for concern among swimmers, surfers, and divers. Divers have been afforded “bang sticks” and chemicals as a means to fend off an attacking shark. Swimmers and surfers are afforded no protection. This shark detection system is designed to provide early warning that a shark is entering the vicinity of humans. The system is expected to utilize existing sonar and radar technology combined with an as-yet-to be developed microprocessor that distinguishes sharks from other objects by size, shape, and other characteristics. Significant testing of the shark detection system in aquariums and the open ocean is anticipated.

### BRIEF SUMMARY OF THE INVENTION

This invention is a shark detection and warning system that consists of an electronic detection system mounted on a buoy in the desired protection zone (swim or surf area). The advantage of this invention is that it protects marine life as well as swimmers. Protective nets applied at beaches in Australia have fatally ensnared non-target marine mammals (turtles) and other sea life. “Bang sticks” and chemicals used by divers are dangerous or pollute the water. Strategically placed shark detection systems will protect resort beaches, ocean stretches used for triathlons, surf areas, public beaches, and diver zones.

### BRIEF DESCRIPTION OF THE SEVERAL VIEWS OF THE DRAWING

The side view of the shark detection buoy begins with the shark detection sensor at the bottom of the buoy. The sensor assembly is housed in solid waterproof material that allows transmission and reception of the detection signal. The weighted immersion arm holds the shark detection assembly underwater. The immersion arm is attached to the main body of the buoy; an air-filled tapered, cylindrical, chamber that houses the battery, microprocessor, and solar power converter. The battery is a standard lead-acid, gel, or other multi-purpose battery for use in supplying power to the shark detection assembly, microprocessor, and transmitter/receiver. The microprocessor is capable of processing signals from the shark detection assembly into usable warnings that are relayed to the audiovisual warning system on the buoy mast. The buoy mast extends from the main body of the buoy and holds the audio warning horns, the warning light assembly, and the transmitter/receiver antenna.

### DETAILED DESCRIPTION OF THE INVENTION

Explanation of Invention and Use

This invention can be described as a buoy system that contains all of the components necessary to detect underwater objects, process the detection signal for shark identification, and then provide an audible and visible warning signal to swimmers from the mast of the buoy. The system starts with a “fish finder” that is commonly employed on private and commercial fishing boats. This invention employs the “fish finder” technology in conjunction with a microprocessor that is capable of processing the signal to locate large objects (sharks) while ignoring smaller objects. The audiovisual warning system is located on a mast that extends from the main body of the buoy. The audiovisual warning will be consist of high-decibel bursts combined with a concurrent flash of the yellow light when potential shark objects are within the detectable range. The audiovisual bursts will increase with intensity as the potential shark object gets closer to shore until it enters the danger zone wherein a constant high decibel audio signal is deployed in conjunction with a rapidly flashing red light. A green light with no audio signal indicates that the unit is powered and functioning properly. The circuits are set up so that, short of power loss, any malfunction in the system will produce a rapidly flashing red light and short audio burst.

Where necessary, a compass is wired to the microprocessor to allow the buoy system to distinguish between beach and outer ocean areas. Installation of directional buoys will require programming the buoy for the specific location, allowing the signal to be applied at approximately a 270-degree arc toward the ocean. This will eliminate signal interference by swimmers.

The buoy system can be used with an underwater pager system for swimmers, surfers, and divers that are unable to monitor the audiovisual signals. The transmitting antenna can issue a warning signal to individuals with accompanying waterproof paging device.

Process of Making

This invention will be made by assembling common materials and employing available technologies. The “fish detector” will be obtained from a manufacturer that consents to use their technology in this application. The immersion arm will consist of a plastic, metal, or plastic coated metal cylinder. The main body of the buoy will be constructed of fiberglass, metal, plastic or plastic coated metal. Batteries, microprocessors, warning lights, horns, antennas, solar panels, and other components presently available will be assembled to produce the prototype.

Significant testing of the “fish detector” and microprocessor is anticipated to allow programming the unit to detect potential shark objects while ignoring other objects. It is anticipated that the unit will require testing in an aquarium and/or open ocean. As the best mode of carrying out this invention, the applicant intends to patent the concept and solicit interest from a “fish detection” manufacturer, a buoy manufacturer, and an electronics firm specializing in microprocessor testing and development. The joint venture will work to synthesize the technologies into a usable product.

Distinction from Other Inventions

Applicant is presently unaware of similar inventions. All patents reviewed under keyword “shark” did not yield anything related to shark detection or warning systems.

1. What I claim as my invention is the concept and design of integrating fish detection technology and microprocessor technology into a buoy system that detects sharks and provides audible, visible, and telecommunication warnings to swimmers, surfers, and divers.
